(19) United States
(12) Patent Application Publication
(10) Pub. No.: US 2026/0024089 A1
(43) Pub. Date: Jan. 22, 2026

(54) METHODS AND SYSTEMS FOR MANAGING DEFAULT RISK ASSOCIATED WITH TRANSIT TRANSACTIONS

(71) Applicant: MASTERCARD INTERNATIONAL INCORPORATED, PURCHASE, NY (US)

(72) Inventors: Sonia GUPTA, Gurgaon (IN); Nikhil TUMBDE, Nagpur (IN); Siddhartha ASTHANA, New Delhi (IN)

(21) Appl. No.: 18/780,453

(22) Filed: Jul. 22, 2024

(51) Int. Cl. G06Q 20/40

(52) U.S. Cl. CPC G06Q 20/4016

(57) ABSTRACT

Methods and systems for managing default risk associated with transit transactions are disclosed. The method performed by server system includes receiving a payment authentication request associated with a transit transaction performed by a payment card and identifying a card status of the payment card, the card status indicating whether the payment card is associated with a risky label or non-risky label. Upon identifying that the payment card is associated with risky label, accessing a pre-auth feature set. Method includes computing, by a pre-auth machine learning model, a pre-auth score based on the pre-auth feature set. Method includes determining a pre-auth amount for a predefined time period based on comparing the pre-auth score with a plurality of predefined pre-auth thresholds and transmitting a risk indication message including at least the card status and the pre-auth amount to the merchant.

### TECHNICAL FIELD

The present disclosure relates to transit transaction in open loop transportation network and, more particularly, to electronic methods and complex processing systems for managing default risk associated with transit transactions.

### BACKGROUND

In an open loop transit system, riders or passengers are allowed to use various payment methods such as contactless payments through a payment card (e.g., a debit or credit card), digital wallets and so on, to perform transit transactions without the need for a dedicated transit card. When the payment method involves contactless payments through the payment card, it is known as a post-paid model. In this post-paid model, the fair for the transportation systems cannot be determined at the point of entry by the transit merchant. As may be understood, since each rider may travel a different distance using the said transportation system, their fare would be different at the end of their journey. Examples of transportation systems include subway system, metro system, monorail system, bus network, ferry system and so on. Conventionally, in the post-paid model at the point of entry, the transit merchant initiates a pre-authorization on the passenger's payment card. Subsequently, the transit merchant logs all the passenger's trips, and charges the total fare to the payment card associated with the said passenger at the end of the day (or a few days). Following this, the pre-authorization is lifted by the transit merchant. In many instances, at the point of entry for a new payment card the transit merchant performs authentication and pre-authorization for a nominal amount.

During the authentication phase, the passenger (or cardholder) may tap their payment card at a transit gate associated with the transit merchant, where the transit merchant confirms its validity, expiry date, and whether it's present on a deny list. Once authenticated, the passenger is allowed access to the transit system. Then, the passenger can be allowed to travel and the transit merchant can log the passenger trips. In the pre-authorization phase, the transit merchant requests a pre-authorization amount on the payment card and once, the total travel fare is computed at the end of the day (or a few days), a payment request may be shared with the issuer of the passenger for clearing the transaction. Although this process allows the transit merchant to perform transit transactions at a high pace during rush or peak hours allowing the passengers to access the transit system quickly, it is associated with a high default risk as well. It is noted that in many instances, passengers might default on the preauthorized amount, i.e., the pre-authorization transaction might fail due a lack of sufficient funds (or Non-Sufficient Funds (NSF)) leading to tremendous losses to the transit systems. These losses may further increase with the subsequent debt recovery process performed to recover these funds.

Conventionally, to address this problem, transit merchants have collaborated with payment gateways to assess transaction risks based on card usage history thereby preventing risky cardholders or passengers from accessing the transit system. However, this risk assessment process is often time taking and may result in longer queues at the entry gates of the transit system. Further, during peak rush hours, using such risk assessment systems might lead to hour long waiting times since the volume of passenger payment cards to be assessed might be in hundreds of thousands across the entire transit system. This leads to a wastage of time for all passengers and might cause to avoid public transportation all together leading to environmental impacts, congestion on public infrastructure at roads and so on. Thus, these conventional approaches cannot be used practically within the open loop transit systems.

To that end, there exists a need for technical solutions such as methods and systems for managing default risk associated with transit transactions while ensuring quick access to the transit system for all the passengers.

### SUMMARY

Various embodiments of the present disclosure provides methods and systems for managing default risk associated with transit transactions.

In an embodiment, a computer-implemented method performed by a server system includes receiving a payment authentication request associated with a transit transaction performed by a payment card associated with a cardholder at a merchant. The computer-implemented method further includes identifying a card status of the payment card, the card status indicating whether the payment card is associated with at least one of a risky label or a non-risky label. The computer-implemented method further includes accessing a pre-auth feature set associated with the payment card from a database associated with the server system, upon identifying that the payment card is associated with a risky label. The computer-implemented method further includes computing by a pre-auth Machine Learning (ML) model associated with the server system, a pre-auth score associated with the payment card based, at least in part, on the pre-auth feature set. The computer-implemented method further includes determining a pre-auth amount associated with the payment card for a predefined time period based, at least in part, on comparing the pre-auth score with a plurality of predefined pre-auth thresholds. The computer-implemented method further includes transmitting a risk indication message including at least the card status and the pre-auth amount to the merchant.

In another embodiment, a server system is disclosed. The server system includes a communication interface and a memory including executable instructions. The server system also includes a processor communicably coupled to the memory. The processor is configured to execute the instructions cause the server system, at least in part, to receive a payment authentication request associated with a transit transaction performed by a payment card associated with a cardholder at a merchant. The server system is further caused to identify a card status of the payment card, the card status indicating whether the payment card is associated with at least one of a risky label or a non-risky label. The server system is further causes to access a pre-auth feature set associated with the payment card from a database associated with the server system upon identifying that the payment card is associated with a risky label. The server system is further caused to compute a pre-auth score associated with the payment card based, at least in part, on the pre-auth feature set using a pre-auth Machine Learning (ML) model associated with the server system. The server system is further caused to determine a pre-auth amount associated with the payment card for a predefined time period based, at least in part, on comparing the pre-auth score with a plurality of predefined pre-auth thresholds. The server system is further caused to transmit a risk indication message including at least the card status and the pre-auth amount to the merchant.

In another embodiment, a non-transitory computer-readable medium including computer-executable instructions is disclosed. When the instructions are executed by at least a processor, the processor causes a server system to perform a method. The method includes receiving a payment authentication request associated with a transit transaction performed by a payment card associated with a cardholder at a merchant. The method further includes identifying a card status of the payment card, the card status indicating whether the payment card is associated with at least one of a risky label or a non-risky label. The method further includes accessing a pre-auth feature set associated with the payment card from a database associated with the server system, upon identifying that the payment card is associated with a risky label. The method further includes computing by a pre-auth Machine Learning (ML) model associated with the server system, a pre-auth score associated with the payment card based, at least in part, on the pre-auth feature set. The method further includes determining a pre-auth amount associated with the payment card for a predefined time period based, at least in part, on comparing the pre-auth score with a plurality of predefined pre-auth thresholds. The method further includes transmitting a risk indication message including at least the card status and the pre-auth amount to the merchant.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present technology, reference is now made to the following descriptions taken in connection with the accompanying drawings in which:

FIG. 1 illustrates a schematic representation of an environment related to at least some example embodiments of the present disclosure;

FIG. 2 illustrates a simplified block diagram of a server system, in accordance with an embodiment of the present disclosure;

FIG. 3A illustrates a block diagram representation depicting a process flow for first entry of cardholder with a new card at a transit entry, in accordance with an embodiment of the present disclosure;

FIG. 3B illustrates a block diagram representation depicting a process flow for second entry of cardholder with a new card at a transit entry, in accordance with an embodiment of the present disclosure;

FIG. 3C illustrates a block diagram representation depicting a process flow generating a risk score and a pre-auth score, in accordance with an embodiment of the present disclosure;

FIG. 4A illustrates a schematic representation of a process of training one or more clearance prediction models for generating the confidence score, in accordance with an embodiment of the present disclosure;

FIG. 4B illustrates a flow diagram representation of a process flow of training one or more clearance prediction models, in accordance with an embodiment of the present disclosure;

FIG. 5 illustrates a process flow diagram depicting a method for identifying the card status, in accordance with an embodiment of the present disclosure;

FIG. 6 illustrates a process flow diagram depicting a method for processing a payment authentication request associated with a transit transaction, in accordance with an embodiment of the present disclosure;

FIG. 7 illustrates a simplified block diagram of an acquirer server, in accordance with an embodiment of the present disclosure;

FIG. 8 illustrates a simplified block diagram of an issuer server, in accordance with an embodiment of the present disclosure; and

FIG. 9 illustrates a simplified block diagram of a payment server, in accordance with an embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

The terms “passenger”, “account holder”, “user”, “cardholder”, “consumer”, “card” and “buyer” are used interchangeably throughout the description and refer to a person who has a payment account or a payment card (e.g., credit card, debit card, etc.) associated with the payment account, that will be used by a transit merchant to perform a payment transaction when the card is tapped at a transit entry. The payment account may be opened via an issuing bank or an issuer server.

The terms “merchant”, “transit merchant” and “transit merchant server”, are used interchangeably throughout the description generally refers to a seller, a retailer, a purchase location, an organization, or any other entity that is in the business of selling transit pass services for passengers, and it can refer to either a single business location or a chain of business locations of the same entity. For example, the transit merchants may include sellers of transit passes at bus station, subways, train stations, metro station etc. The transit merchants may include sellers of transit passes via e-commerce and physical ticketing too.

The terms “payment network” and “card network” are used interchangeably throughout the description and refer to a network or collection of systems used for the transfer of funds through the use of cash substitutes. Payment networks may use a variety of different protocols and procedures to process the transfer of money for various types of transactions. Payment networks are companies that connect an issuing bank with an acquiring bank to facilitate online payment. Transactions that may be performed via a payment network may include product or service purchases, credit purchases, debit transactions, fund transfers, account withdrawals, etc. Payment networks may be configured to perform transactions via cash substitutes that may include payment cards, letters of credit checks, financial accounts, etc. Examples of networks or systems configured to perform as payment networks include those operated by a fintech organization.

The term “payment card”, “new card”, and “card”, used throughout the description, refers to a physical or virtual card linked with a financial or payment account that may be presented to a transit merchant or any such facility to fund a financial transaction via the associated payment account for availing transit services. Additionally, the new card also refers to a card which is being used at a transit entry for the very first time or after a very long time e.g. 6 month, 9 month or 1 year and more to avail transit service. Examples of the payment card include, but are not limited to, debit cards, credit cards, prepaid cards, virtual payment numbers, virtual card numbers, forex cards, charge cards, e-wallet cards, and stored-value cards. A payment card may be a physical card that may be presented to the transit merchant for funding the payment.

Alternatively, or additionally, the payment card may be embodied in the form of data stored in a user device, where the data is associated with a payment account such that the data can be used to process the financial transaction between the payment account and a transit merchant's financial account. In some instances, while swiping the payment card at the transit merchant's end, the transit merchant can raise a preauthorization request to check the eligibility of the merchant to use the service that the cardholder is willing to receive from the merchant. In this case, the payment will not be made at the beginning of receiving the service, instead, it will be made upon completion of the service or at the time of checking out. Herein, the payment may or may not be the same as the amount requested in the preauthorization request.

The term “payment account” used throughout the description refers to a financial account that is used to fund a financial transaction. Examples of the financial account include, but are not limited to, a savings account, a credit account, a checking account, and a virtual payment account. The financial account may be associated with an entity such as an individual person, a family, a commercial entity, a company, a corporation, a governmental entity, a non-profit organization, and the like. In some scenarios, the financial account may be a virtual or temporary payment account that can be mapped or linked to a primary financial account, such as those accounts managed by payment wallet service providers, and the like.

The terms “payment transaction,” “financial transaction,” “event,” “tapping,” and “transaction” are used interchangeably throughout the description and refer to a transaction initiated by the cardholder for the payment of a certain amount. Specifically, a transit transaction refers to an electronic financial transaction related to public transportation services. This includes actions such as tapping a card at a transit terminal or entry gate, purchasing a transit ticket from a self-service kiosk or point of sale (POS) terminal, and similar activities. In some cases, a preauthorization may occur, where the actual payment transaction is completed only after the transit service has been received.

### Overview

Various embodiments of the present disclosure provide methods, systems electronic devices, and computer program products for managing default risk associated with transit transactions.

In an embodiment, the server system may be a payment server associated with a payment network that is configured to receive a payment authentication request associated with a transit transaction performed by a payment card associated with a cardholder at a merchant.

In another embodiment, the server system is configured to identify a card status of the payment card, the card status indicating whether the payment card is associated with at least one of a risky label or a non-risky label. Herein, the card status associated with the payment card is valid for a predefined status time interval.

To identify a card status of the payment card, the server system is configured to determine if the payment card is associated with the card status in the database. Then, the server system is configured to access a risk feature set associated with the payment card from the database, upon determining that the payment card is not associated with the card status. Thereafter, the server system is configured to compute, using a risk ML model associated with the server system, a risk score associated with the payment card based, at least in part, on the risk feature set and assign the card status to the payment card based, at least in part, on comparing the risk score with a predefined risk threshold, wherein the card status indicates at least one of the risky label or the non-risky label. Herein, the risk ML model is a binary classification model.

To access the risk feature set, the server system is configured to access a historical transaction dataset from the database, the historical transaction dataset including transaction-related information associated with a plurality of transactions performed by a plurality of cardholders with a plurality of merchants. Then, the server system is configured to generate the risk feature set based, at least in part, on the transaction-related information associated with the plurality of transactions, wherein the risk feature set includes a set of first card-level features and a set of first merchant-level features and store the risk feature set in the database.

In another embodiment, the server system is configured to access a pre-auth feature set associated with the payment card from a database associated with the server system. Further, the server system is configured to compute a pre-auth score associated with the payment card based, at least in part, on the pre-auth feature set using a pre-auth Machine Learning (ML) Model associated with the server system, upon identifying that the payment card is associated with a risky label. Herein, the pre-auth ML model is a multiclass classification model.

To access the pre-auth feature set, the server system is configured to access, a historical transaction dataset from the database, the historical transaction dataset including transaction-related information associated with a plurality of transactions performed by a plurality of cardholders with a plurality of merchants. Then, the server system is configured to generate, the pre-auth feature set based, at least in part, on the transaction-related information associated with the plurality of transactions, wherein the pre-auth feature set includes a set of second card-level features and a set of second merchant-level features and store the pre-auth feature set in the database.

In another embodiment, the server system is configured to determine a pre-auth amount associated with the payment card for a predefined time period based, at least in part, on comparing the pre-auth score with a plurality of predefined pre-auth thresholds. Additionally, the server system is configured to transmit a risk indication message including at least the card status and the pre-auth amount to the merchant. Herein, the predefined time period indicates a time interval during which the merchant has to transmit a clearing request message for the pre-auth amount to the issuer server associated with the cardholder.

In an additional embodiment, the server system is configured to transmit the risk indication message including at least the card status to the merchant, upon identifying that the payment card is associated with a non-risky label.

Various embodiments of the present disclosure provide innovative methods and systems for managing default risk associated with transit transactions, and they offer several significant technical effects and solve the technical problem described herein. First and foremost, these methods and systems effectively reduce the risk of defaults, ensuring more reliable fare collection for transit authorities. This reduction in default risk translates directly into fewer financial losses, which has a cascade of positive effects. With fewer financial losses, transit authorities can avoid job cuts and instead focus on improving working conditions for their employees. Moreover, efficient fare collection means passengers spend less time waiting, making public transportation a more attractive option. Increased use of public transit not only alleviates traffic congestion but also significantly reduces pollution, contributing to a cleaner environment.

In a metropolitan city, the open-loop transit system allows passengers to pay for their journeys using contactless payment methods such as credit cards, debit cards, and digital wallets. During peak hours, thousands of passengers flock to subway stations, bus stops, and ferry terminals, creating a high demand for quick and efficient entry into the transit system. The current system requires a pre-authorization for a nominal amount at the entry gate, followed by logging each trip and charging the total fare at the end of the day. This can lead to significant delays and queuing, especially during rush hours, as well as a high risk of default on payments due to insufficient funds. Implementing the plug-and-play solution provided by the present disclosure can revolutionize this scenario. As passengers tap their payment cards at the gate, the system instantly assesses the risk of default using advanced algorithms and real-time data from payment gateways. This rapid risk assessment ensures that only passengers with a high likelihood of payment approval are granted access, significantly reducing the chances of transaction failures. By reducing the instances of payment defaults, the transit system also minimizes revenue losses and avoids the costly and time-consuming debt recovery process. This leads to a more financially stable and reliable transit service.

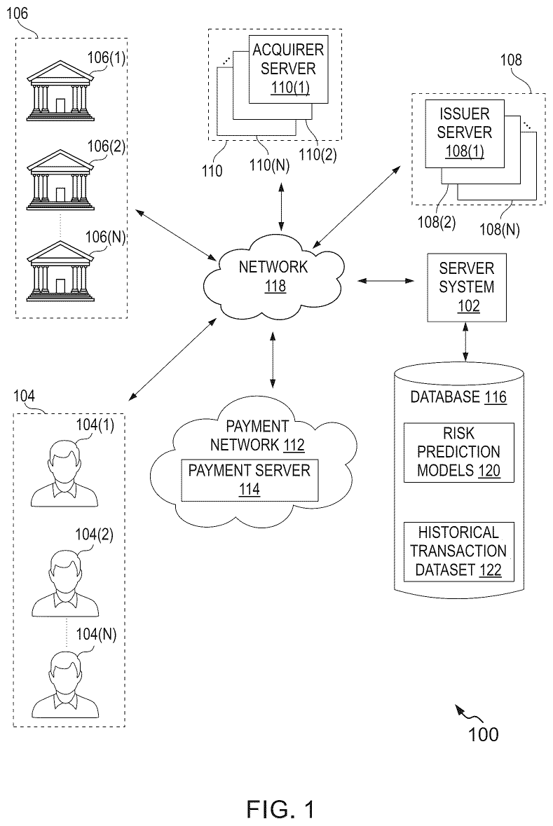

Various example embodiments of the present disclosure are described hereinafter with reference to FIGS. 1 to 8.

FIG. 1 illustrates a block diagram representation of an environment 100 related to at least some example embodiments of the present disclosure.

The environment 100 generally includes a plurality of entities such as a server system 102, a plurality of cardholders 104(1), 104(2), . . . 104(N), where ‘N’ is a non-zero natural number (collectively referred to as a ‘plurality of cardholders 104’ or ‘cardholders 104’ or singularly as ‘cardholder 104(1)’), a plurality of merchants 106(1), 106(2), . . . 106(N) where ‘N’ is a non-zero natural number (collectively referred to as a ‘plurality of merchants 106’ or ‘merchants 106’ or singularly as ‘merchant 106(1)’), a plurality of issuer servers 108(1), 108(2), . . . 108(N), where ‘N’ is a non-zero natural number (collectively referred to as a ‘plurality of issuer servers 108’ or ‘issuer servers 108’ or singularly as ‘issuer server 108(1)’), a plurality of acquirer servers 110(1), 110(2), . . . , 110(N), where ‘N’ is a non-zero natural number (collectively referred to as a ‘plurality of acquirer servers 110’ or ‘acquirer servers 110’ or singularly as ‘acquirer server 110(1)’), a payment network 112 including a payment server 114, and a database 116 each coupled to, and in communication with (and/or with access to) a network 118. It is noted that the plurality of merchants 106(1), 106(2), . . . , 106(N) includes at least one transit merchants such as a transit merchant 106(1).

In various examples, the network 118 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof.

Various entities in the environment 100 may connect to the network 118 in accordance with various wired and wireless communication protocols, such as Transmission Control Protocol and Internet Protocol (TCP/IP), User Datagram Protocol (UDP), 2nd Generation 2G), 3rd Generation 3G), 4th Generation 4G), 5th Generation 5G) communication protocols, Long Term Evolution (LTE) communication protocols, New Radio (NR) communication protocol, any future communication protocol, or any combination thereof. In some instances, the network 118 may utilize a secure protocol (e.g., Hypertext Transfer Protocol (HTTP), Secure Socket Lock (SSL), and/or any other protocol, or set of protocols for communicating with the various entities depicted in FIG. 1.

In an embodiment, the cardholders 104 use one or more payment cards (not shown) to make payment transactions. As may be understood, the cardholder (e.g., the cardholder 104(1)) may be any individual, representative of a corporate entity, a non-profit organization, or any other person that is presenting payment account details during an electronic payment transaction. The cardholder (e.g., the cardholder 104(1)) may have a payment account issued by an issuing bank (not shown in figures) associated with the issuer server 108 and may be provided with a payment card with financial or other account information encoded onto the payment card such that the cardholder (i.e., the cardholder 104(1)) may use the payment card to initiate and complete a payment transaction using a bank account at the issuing bank.

In another embodiment, the cardholders 104 may use their corresponding electronic devices (not shown) to access a mobile application or a website associated with the issuing bank, or any third-party payment application to perform a payment transaction such as the transit transaction. In various non-limiting examples, the electronic devices may refer to any electronic devices such as, but not limited to, personal computers (PCs), tablet devices, smart wearable devices, Personal Digital Assistants (PDAs), voice-activated assistants, Virtual Reality (VR) devices, smartphones, laptops, and the like.

In one embodiment, the cardholders 104 are associated with the issuer servers 108. In one embodiment, the issuer servers 108 are associated with financial institutions normally called an “issuer bank”, “issuing bank” or simply “issuer”, in which a cardholder (e.g., the cardholder 104(1)) may have the payment account, (which also issues a payment card, such as a credit card or a debit card), and provides microfinance banking services (e.g., payment transaction using credit/debit cards) for processing electronic payment transactions, to the cardholder (e.g., the cardholder 104(1)).

In an embodiment, the merchants 106 may include, but not limited to, retail ticket stores for transit services, government and/or private agencies associated with transit service, or any such places equipped with POS terminals, where cardholders 104 visit for performing the financial transaction in exchange for physical or virtual transit pass or travel tickets. Instances of transit service may include, but not limited to, subway, railway, metro, mass rapid transit, bus or cab services, tram, ropeways etc.

In one scenario, the cardholders 104 may use their corresponding payment accounts to conduct payment transactions with the merchants 106. Moreover, it may be noted that each of the cardholders 104 may use their corresponding payment cards differently or make the payment transaction using different means of payment. The term “payment transaction” refers to an agreement that is carried out between a buyer and a seller to exchange goods or services in exchange for assets in the form of a payment (e.g., cash, fiat-currency, digital asset, cryptographic currency, coins, tokens, etc.).

For instance, the cardholder 104(1) (may also be called a passenger 104(1)) may enter payment account details on an electronic device (not shown) associated with the cardholder 104(1) to perform a transit transaction by tapping or swiping their payment card on a terminal associated with a transit merchant 106(1). In another example, the cardholder 104(2) may utilize the payment card to perform an offline payment transaction using a Point of Sale (POS) device at the transit merchant's store. In yet another example, the cardholder 104(3) may enter details of the payment card to transfer funds in the form of fiat currency on an e-commerce platform to buy a transit pass or travel ticket. In other words, each cardholder of the plurality of cardholders 104 (e.g., the cardholder 104(1)) may transact at any transit merchant such as by tapping a card on an electronic device (not shown) associated with a transit entry to perform an online payment transaction with the transit merchant 106(1).

In an embodiment, the merchants 106 are generally associated with the acquirer servers 110. In one embodiment, the acquirer servers 110 are associated with financial institutions (e.g., a bank) that process financial transactions for the merchants 106. This can be an institution that facilitates the processing of payment transactions for physical stores, transit merchants, or institutions that own platforms that make either online purchases or purchases made via software applications possible. The terms “acquirer”, “acquiring bank”, “acquiring bank” or “acquirer server” will be used interchangeably herein.

In one embodiment, the payment network 112 may be used by the payment card issuing authorities as a payment interchange network. Examples of the payment cards include debit cards, credit cards, etc. Similarly, examples of payment interchange networks include but are not limited to, a fintech organization payment system interchange network. The fintech organization payment system interchanges for the exchange of electronic payment transaction data between issuers and acquirers that are members of the fintech organization. The payment network 112 includes the payment server 114 which is responsible for facilitating the various operations of the payment network 112. In one scenario, the payment server 114 is configured to operate a payment gateway for facilitating the various entities in the payment network 112 to perform digital transactions including transit transactions.

As described earlier, in open-loop transit systems, passengers use various contactless payment methods, like debit or credit cards and digital wallets, to perform transit transactions without a dedicated transit card. This post-paid model, which can be considered as a deferred payment authentication model, where fares are calculated at the end of the journey, involves pre-authorizing a nominal amount at entry. However, this model carries a high risk of payment defaults due to insufficient funds, leading to significant financial losses and costly debt recovery for transit systems. Traditional risk assessment methods are time-consuming and cause long queues during peak hours. Therefore, there is a pressing need for efficient technical solutions to manage payment default risks while ensuring quick access for passengers.

The above-mentioned technical problems, among other problems, are addressed by one or more embodiments implemented by the server system 102 and methods thereof provided in the present disclosure. In one embodiment, the server system is configured to predict the risk associated with a payment card as well as a recommended pre-auth amount for a risky card that may be requested by the transit merchant 106(1) from such cardholders for availing the transit facilities in real-time.

In some embodiments, the server system 102 may be deployed as a standalone server or may be implemented in the cloud as software as a service (SaaS). In one embodiment, the environment 100 may further include a database 116 coupled with the server system 102. In an example, the server system 102 coupled with the database 116 is embodied within the payment server 114, however, in other examples, the server system 102 can be a standalone component (acting as a hub) connected to the acquirers 110 and the issuers 108. The database 116 may be incorporated in the server system 102 or maybe an individual entity connected to the server system 102 or maybe a database stored in cloud storage. In one embodiment, the database 116 may store one or more risk prediction models 120 (such as risk ML model and pre-auth ML model), historical transaction dataset 122, and other necessary machine instructions required for implementing the various functionalities of the server system 102 such as firmware data, operating system, and the like. The one or more risk prediction models 120 is represented in the FIG. 1 as risk prediction models 120.

In various non-limiting examples, the database 116 may include one or more Hard Disk Drives (HDD), Solid-State Drives (SSD), an Advanced Technology Attachment (ATA) adapter, a Serial ATA (SATA) adapter, a Small Computer System Interface (SCSI) adapter, a redundant array of independent disks (RAID) controller, a Storage Area Network (SAN) adapter, a network adapter, and/or any component providing the server system 102 with access to the database. In one implementation, the database may be viewed, accessed, amended, updated, and/or deleted by an administrator (not shown) associated with the server system 102 through a database management system (DBMS) or relational database management system (RDBMS) present within the database 116.

In other various examples, the database may also include multifarious data, for example, social media data, Know Your Customer (KYC) data, payment data, trade data, employee data, Anti Money Laundering (AML) data, market abuse data, Foreign Account Tax Compliance Act (FATCA) data, and fraudulent payment transaction data. In addition, the database provides a storage location for data and/or metadata obtained from various operations performed by the server system 102.

In an embodiment, the historical transaction dataset 122 may include transaction-related information related to a plurality of payment transactions performed between a plurality of cardholders 104 with a plurality of merchants 106 within the payment network 112. The historical transaction dataset may include but is not limited to, transaction-related information, such as transaction amount, source of funds such as bank or credit cards, transaction channel used for loading funds such as POS terminal or ATM, transaction velocity features such as count and transaction amount sent in the past ‘x’ number of days to a particular user or cardholder, transaction location information, external data sources, merchant country, merchant Identifier (ID), cardholder ID, cardholder product, Merchant Category Code (MCC), merchant location data or merchant co-ordinates, merchant name, city, zip code merchant industry, merchant super industry, ticket price or ticket Size, number of unique cards, location, transaction channel (POS/Ecomm/Cash), product code and other transaction-related data. The historical transaction dataset 122 may be used by the server system 102 to generate one or more card level features (such as first card level features and second card level features) and one or more merchant level features (such as first merchant level features and second merchant level features) using one or more featurization techniques.

In an embodiment, the one or more risk prediction models 120 may refer AI or ML models that are configured to determine the risk associated with a payment card and allowable pre-authorization amount (interchangeably used as pre-auth amount throughout the present invention) for the payment card. In various non-limiting examples, the one or more risk prediction models 120 may include Decision Tree based ML models or algorithms such as eXtreme Gradient Boosting (XGBoost), Catboost (Categorical Boosting), LightGBM (Gradient Boosting Machines), Random Forest, DNN (Deep Neural Network) models, and the like.

In an embodiment, the server system 102 is configured to receive a payment authentication request associated with a transit transaction performed by a payment card associated with a cardholder 104(1) at a merchant (may be called a transit merchant 106(1)). Then, the server system 102 is configured to identify a card status of the payment card. The card status may indicate whether the payment card is associated with at least one of a risky label or a non-risky label. Herein, the card status associated with the payment card is valid for a predefined status time interval. In other words, after the predefined status time interval elapses, the server system 102 considers the corresponding payment card as a new payment card and the corresponding cardholder as a new user for the transit network.

More specifically, to identify a card status of the payment card, the server system 102 is configured to determine if the payment card is associated with the card status in the database 116. If yes, then the same status is utilized by the server system 102. Otherwise, if no, then, the server system 102 is configured to access a risk feature set associated with the payment card from the database 116. Thereafter, the server system 102 is configured to compute, using a risk ML model associated with the server system 102, a risk score associated with the payment card 10 based, at least in part, on the risk feature set. Thereafter, the server system 102 assigns a card status to the payment card based, at least in part, on comparing the risk score with a predefined risk threshold. This card status is either a risky label or a non-risky label indicating whether the payment card is at risk of defaulting on the amount of the transit transaction in future.

The predefined risk threshold may refer to a threshold value set up or defined by an administrator (not shown) of the server system 102 above which the risk score indicates a high risk of the cardholder defaulting on the payment amount of the transit transaction. Herein, the risk ML model may be a binary classification model. In another embodiment, the risk ML model can be a binary classification model using XGBoost with BCE (Binary Cross-Entropy) loss function and a neural network with one neuron in the last layer trained using BCE loss. In some instances, the server system 102 may be configured to transmit the risk indication message including the card status to the merchant 106(1), upon identifying that the payment card is associated with a non-risky label.

In another embodiment, the server system 102 is configured to access a pre-auth feature set associated with the payment card from a database 116 associated with the server system 102. Further, the server system 102 is configured to compute a pre-auth score associated with the payment card based, at least in part, on the pre-auth feature set using a pre-auth Machine Learning (ML) model, upon identifying that the payment card is associated with a risky label. Herein, the pre-auth ML model may be a multiclass classification model. In another embodiment the pre-auth ML model can be a multiclass classification model using XGBoost with the Multi-class Cross-Entropy loss function and a neural network with multiple neurons in the last layer trained using the same loss function.

In another embodiment, the server system 102 is configured to determine a pre-auth amount associated with the payment card for a predefined time period based, at least in part, on comparing the pre-auth score with a plurality of predefined pre-auth thresholds. The predefined pre-auth thresholds may refer to a set of rules set up or defined by an administrator (not shown) of the server system 102 to determine the pre-auth amount based on the determined pre-auth score. Additionally, the server system 102 is configured to transmit a risk indication message including at least the card status and the pre-auth amount to the merchant 106(1) (may be called the transit merchant 106(1)). Herein, the predefined time period indicates a time interval during which the merchant 106(1) has to transmit a clearing request message for the pre-auth amount to the issuer server 108(1) associated with the cardholder 104(1) for the said payment card.

In another embodiment, the transit merchant 106(1) may be associated with a merchant server (not shown). The merchant server may include at least a communication interface, at least one memory module including executable instructions and at least one processor. The processor is communicably coupled to the communication interface and the at least one memory module. Further, when the processor processes the executable instruction, the processor causes the merchant server to receive at least one of a card status and a pre-auth amount associated with a new card from the server system 102. Then, the merchant server may cause the transit merchant 106(1) to perform at least one of a plurality of predefined actions in association with the transaction based on at least one of the risk score and the pre-auth score.

In an additional embodiment, the at least one of a plurality of predefined actions includes at least one of allowing entry of the cardholder at the transit entry on a first entry if the card status is non-risky (or non-risky label), sending a pre-authorization request with the pre-auth amount to an issuer server via an acquirer server for a second transaction request associated with the new card on a second entry at the transit entry if the card status is risky (or risky label), upon approval of the pre-authorization request by the issuer server, allowing entry of the cardholder at the transit entry to access the transit services on the second entry, and upon non-approval of the pre-authorization request by the issuer server, denying entry of the cardholder at the transit entry to access the transit services on the second entry.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device is shown in FIG. 1 may be implemented as multiple, distributed systems or devices. In addition, the server system 102 should be understood to be embodied in at least one computing device in communication with the network 118, which may be specifically configured, via executable instructions, to perform steps as described herein, and/or embodied in at least one non-transitory computer-readable media.

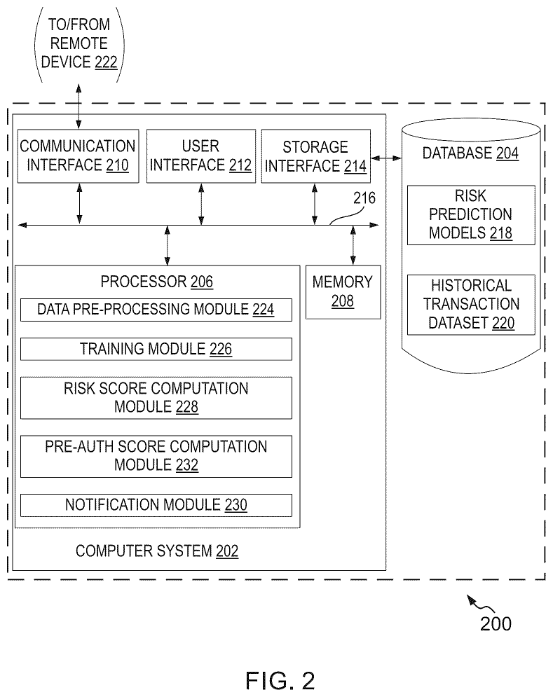

FIG. 2 illustrates a simplified block diagram of a server system 200, in accordance with an embodiment of the present disclosure. The server system 200 is identical to the server system 102 of FIG. 1. In one embodiment, the server system 200 is a part of the payment network 112 or integrated within the payment server 114. In some embodiments, the server system 200 is embodied as a cloud-based and/or SaaS-based (software as a service) architecture.

The server system 200 includes a computer system 202 and a database 204. The computer system 202 includes at least one processor 206 for executing instructions, a memory 208, a communication interface 210, a user interface 212, and a storage interface 214. The one or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities.

In some embodiments, the database 204 is integrated into the computer system 202. In one non-limiting example, the database 204 is configured to store one or more risk prediction models 218 (such as a risk ML model and a pre-auth ML model), a historical transaction dataset 220 among other relevant instructions for operating the server system 200. Herein, the one or more risk prediction models 218 and the historical transaction dataset 220 are identical to the one or more risk prediction models 120 and the historical transaction dataset 122 of FIG. 1.

In an embodiment, the computer system 202 may include one or more hard disk drives as the database 204. The user interface 212 is an interface such as a Human Machine Interface (HMI) or a software application that allows users such as an administrator (not shown) to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

In an embodiment, the storage interface 214 is any component capable of providing the processor 206 access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

The processor 206 includes suitable logic, circuitry, and/or interfaces to execute operations for managing default risk associated with transit transactions and so on. Examples of the processor 206 include, but are not limited to, an application-specific integrated circuit (ASIC) processor, a reduced instruction set computing (RISC) processor, a graphical processing unit (GPU), a complex instruction set computing (CISC) processor, a field-programmable gate array (FPGA), and the like.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 222 such as the issuer servers 108, the acquirer servers 110, the payment server 114, the merchant server associated with the merchant (e.g. a transit merchant 106(1)) or communicating with any entity connected to the network 118 (as shown in FIG. 1.)

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2. It should be noted that the server system 200 is identical to the server system 102 described in reference to FIG. 1.

In one implementation, the processor 206 includes a data pre-processing module 224, a training module 226, a risk score computation module 228, a pre-auth score computation module 232, and a notification module 230 in reference to FIG. 2. It should be noted that components, described herein, such as the data pre-processing module 224, the training module 226, the risk score computation module 228, the pre-auth score module 232, and the notification module 230 can be configured in a variety of ways, including electronic circuitries, digital arithmetic, and logic blocks, and memory systems in combination with software, firmware, and embedded technologies.

In an embodiment, the data pre-processing module 224 includes suitable logic and/or interfaces for receiving a payment authentication request associated with a transit transaction performed by a payment card associated with a cardholder such as cardholder 104(1) at a merchant such as transit merchant server 106(1). In particular, initially the cardholder 104 such as cardholder 104(1) performs a transaction at a transit entry with a payment card such as a new card. The merchant such as a transit merchant 106(1) transmits the payment card information along with relevant authentication information to the acquirer server 110(1). Then, the acquirer server 110(1) transmits a payment authorization request message to the issuer server 108(1). The issuer servers perform various authentication processes to determine the validity of the cardholder presenting the payment card. If the authentication is successful, the issuer transmits the authentication successful message as the payment authentication response message (simply, the payment authorization message) to the acquirer server 110 via the server system 200.

Further, the data pre-processing module 224 is configured to generate a risk feature set and a pre-auth feature set associated with payment card. In particular, the data pre-processing module 224 is configured to access the historical transaction dataset 220 from the database 204. In various examples, the historical transaction dataset 220 may include at least the transaction-related information associated with a plurality of transactions performed by a plurality of cardholders 104 with a plurality of merchants 106. In some instances, the historical transaction dataset 220 may also be called merchant-cardholder interaction data. The historical transaction dataset 220 may include but is not limited to, one or more transaction attributes, such as transaction amount, source of funds such as bank or credit cards, transaction channel used for loading funds such as POS terminal, transit entry card tapping at a transit terminal, or ATM, transaction velocity features such as count and transaction amount sent in the past ‘x’ number of days to a particular cardholder, transaction location information, external data sources, merchant country, merchant Identifier (ID), cardholder ID, cardholder product, Merchant Category Code (MCC), merchant location data or merchant co-ordinates, merchant name, city, zip code merchant industry, merchant super industry, ticket price or ticket Size, number of unique cards, location, transaction channel (POS/Ecomm/Cash), product code and other transaction-related data.

Further, the data pre-processing module 224 is configured is configured to generate the risk feature set based, at least in part, on the transaction-related information associated with the plurality of transactions. Herein, the risk feature set includes a set of first card-level features and a set of first merchant-level features. In some instances, the data pre-processing module 224 may utilize existing featurization techniques such as one-hot encoding, logarithmic transformation, binning, and so on to generate the features described herein. It is noted that since these techniques are well-known in the art, they have not been explained here for the sake of brevity. Then, the risk feature set is stored in the database 204 to be used or accessed later on.

In an embodiment, the risk feature set may include at least one of a set of first card level features and a set of first merchant level features. The first card level features include, but not limited to, metrics associated with at least one of frequency of the card going from pre-authorization to debt recovery in transactions associate with transit, number of past predefined duration pre-authorization declines on aggregated split recovery transactions, number of past predefined duration pre-authorization approvals for aggregated split clearing transactions and number of days between past predefined duration pre-authorization.

Further, the first merchant level features may include, but not limited to, metrics associated with at least one of number of transactions with same merchant, first ride indicator, declines on past predefined duration pre-authorization transaction with a merchant, number of approved transactions with other merchants in same merchant category code, number of declined with other merchants in same merchant category code, number of preauthorized declines with other merchant belonging to merchant category code associated with transit services.

Further, the data pre-processing module 224 is configured to generate the pre-auth feature set based, at least in part, on the transaction-related information associated with the plurality of transactions. Herein, the pre-auth feature set includes a set of second card-level features and a set of second merchant-level features. In some instances, the data pre-processing module 224 may utilize existing featurization techniques such as one-hot encoding, logarithmic transformation, binning, and so on to generate the features described herein. It is noted that since these techniques are well-known in the art, they have not been explained here for the sake of brevity. Then, the pre-auth feature set is stored in the database 204 to be used or accessed later on.

In another embodiment, the pre-auth feature set includes at least one of a set of second card level feature and a set of second merchant level features. The second card level features include, but not limited to, metrics associated with at least one of transaction amount goes from pre-auth to debt recovery in transactions associated with transit, amount in past predefined duration pre-authorization declines on aggregated split recovery transactions, amount in past predefined duration pre-authorization approvals for aggregated split clearing transactions, number of days between past predefined duration pre-authorizations, number of pre-authorizations in past predefined duration greater than or equal to a predetermined amount, number of pre-authorizations in past predefined duration less than the predetermined amount, number of days associated with a transaction debt recovery, number of attempts with a transaction debt recovery, amount associated with a declined transaction of debt recovery.

Further, the second merchant level features include, but not limited to, metrics associated with at least one of number of transactions with same merchant, transactions amount with same merchant and different merchant of same merchant category code, amount for first rides with the same merchant and different merchant from same merchant category code, decline amount on past predefined duration pre-authorization transaction with a merchant and amount of pre-authorization declines with other merchant belonging to merchant category code associated with transit services.

In some embodiments, before the generation of the features, the data pre-processing module 224 may be configured to gather data samples and store them in the historical transaction dataset 220. Further, the data pre-processing module 224 may be configured to perform pre-processing steps such as handling missing values, scaling the features, encoding categorical variables, and splitting the data into training and testing sets as well. In some other embodiments, upon generating the different feature sets, the data pre-processing module 224 may be configured to select a subset of relevant features from the plurality of features for reducing dimensionality and improving model's efficiency and generalization.

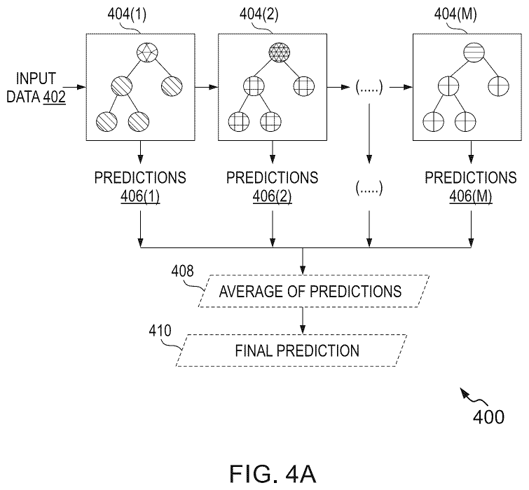

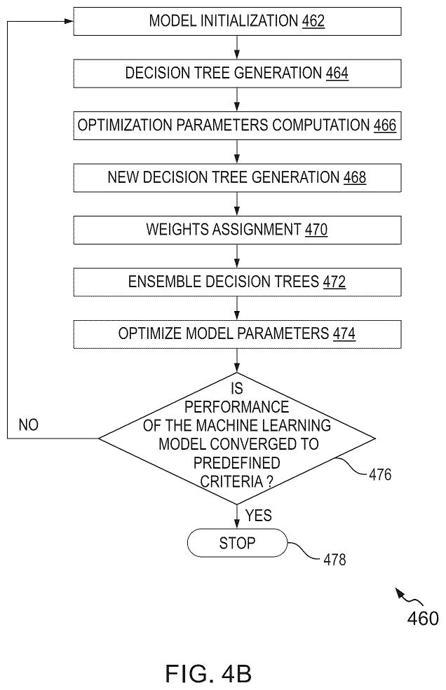

In another embodiment, the data pre-processing module 224 is communicably coupled to the training module 226 and a risk score computation module 228 and a pre-auth score computation module 232. The data pre-processing module 224 is configured to transmit the risk feature set and the pre-authorization feature set to the training module 226, the risk score computation module 228, and the pre-auth score computation module 232. In an embodiment, the training module 226 includes suitable logic and/or interfaces for training the one or more risk prediction models 218 based on the historical transaction dataset 220. It is noted that the training or learning process of the one or more risk prediction models 218 has been described later in reference to FIG. 4A and FIG. 4B. The same is not explained here for the sake of brevity.

In an embodiment, the risk score computation module 228 includes suitable logic and/or interfaces for generating, by the one or more risk prediction models 218, a risk score for the transaction request at the transit entry based, at least in part, on the risk feature set. More specifically, the risk score computation module 228 is configured to determine, by at least one model (called, a risk ML model) from the one or more risk prediction models 218, a risk score associated with a card based, at least in part, on the risk feature set. Herein, the risk score represents a likelihood of the cardholder defaulting on the payment amount of the transit transaction. In particular, the risk ML model utilizes the risk feature set to compute the risk score associated with the payment card.

Further, the risk score computation module 228 is configured to determine if the payment card is associated with the card status in the database. If yes, this card status indicates that the payment card is an old card that has been used before at the transit merchant 106(1). However, upon determining that the payment card is not associated with the card status, it may be understood that the payment card is a new payment card transacting at the transit merchant 106(1). In this case, the risk score computation module 228 is configured to access a risk feature set associated with the payment card from the database 204. Further, the risk score computation module 228 is configured to compute, using the Risk ML model, a risk score associated with the payment card based, at least in part, on the risk feature set. Then, the risk score computation module 228 is configured to assign the card status to the payment card based, at least in part, on comparing the risk score with a predefined risk threshold. As described earlier, the card status indicates at least one of the risky label or the non-risky label. It is noted that the card status may be valid for a predefined status time interval. Upon expiry of this validity, the card status may be reset to Null. In other words, even an old payment card may be treated as a new payment card after the predefined status time interval.

In an embodiment, the risk score computation module 228 may compare the risk score with a predefined risk threshold. In some instances, the risk score may be represented as a percentage between 0% to 100% or simply, a value between 0 to 100. In a non-limiting example, the risk score may be a number between 0 and 1 when normalized. Now, upon comparing with the predefined risk threshold, the risk score computation module 228 may determine a likelihood of the cardholder associated with a new card defaulting on the transit transaction. For instance, if the predefined risk threshold is 0.9 and the risk score is 0.8. Then, the risk score computation module 228 can determine that the transaction is a good-to-go and assign the card status as non-risky (i.e., a non-risky label is assigned as the card status). In an alternative instance, if the predefined risk threshold value is 0.9 and the transaction clearance likelihood score is 0.98. Then, the risk score computation module 228 may determine that the transaction will result default or to go for recovery of the pending balance for the transit transaction and the card is risky (i.e., a risky label is assigned as the card status).

In an embodiment, the pre-auth score computation module 232 includes suitable logic and/or interfaces. The pre-auth score computation module 232 is configured to compute a pre-auth score associated with the payment card based, at least in part, on the pre-auth feature set using a pre-auth ML model associated with the server system 200. It should be noted that the pre-auth score computation module 232 may utilize one or more outputs of the risk score computation module 228 for computing the pre-auth score associated with the card.

In particular, the pre-auth score computation module 232 is configured to identify a card status of the payment card, the card status indicating whether the payment card is associated with at least one of a risky label or a non-risky label. Upon identifying that the payment card is associated with a risky label, the pre-auth score computation module 232 is configured to access a pre-auth feature set associated with the payment card from a database 204 associated with the server system 200. The generation of the said pre-auth feature set has been described earlier. Further, the pre-auth score computation module 232 is configured to compute a pre-auth score associated with the payment card based, at least in part, on the pre-auth feature set using the pre-auth ML model. Thereafter, the pre-auth computation module 232 is configured to determine a pre-auth amount associated with the payment card for a predefined time period based, at least in part, on comparing the pre-auth score with a plurality of predefined pre-auth thresholds.

In an embodiment, the pre-auth score computation module 232 may compare the pre-auth score with a second plurality of predefined threshold values. In some instances, the pre-auth score may be represented as a percentage between 0% to 100% or simply, a value between 0 to 100. In a non-limiting example, the pre-auth score may be a number between 0 and 1 when normalized. Now, upon comparing with the second plurality predefined threshold value, the pre-auth score computation module 232 may determine a pre-auth amount from a plurality of pre-auth amounts associated with the second plurality of the predefined threshold values, if the new card status is risky. For instance, if for second plurality threshold values 0.50-0.59, 0.60-0.69, 0.70-0.79, and 0.80-0.89, corresponding pre-auth amounts are $10, $15, $20, and $25, and the pre-auth score is 0.71 for a card with risky status, then the pre-auth score computation module 232 can determine that a pre-auth amount associated with the card is $20. In an alternative instance, if the card status is non-risky (or non-risky label) then the card is good-to-go, then there is no need to determine a pre-auth amount for the card.

In another embodiment, the risk score computation module 228 and the pre-auth score computation module 232 are communicably coupled to the notification module 230 and are configured to transmit the card status and the pre-auth amount, combined or individually, (e.g. risky card: pre-auth for next tap with amount or non-risky card: good to go) to the notification module 230.

In an embodiment, the notification module 230 includes suitable logic and/or interfaces for generating and transmitting one or more messages associated with at least one of the risk score and the pre-auth amount to the transit merchant 106(1). The one or more messages may include at least one of the risk score, the pre-auth score, the card status, and the pre-auth amount. In particular, the notification module 230 is configured to generate and transmit a risk indication message including at least the card status and the pre-auth amount to the merchant, i.e., the transit merchant 106(1).

In an alternative embodiment, the notification module 230 is configured to transmit the message associated with the card status (e.g., risky label and non-risky label) and the pre-auth amount to the transit merchant server 110(1). In some instances, the various messages exchange between the acquirer server, the server system and the issuer server may be Application Programming Interface (API) or extended markup language (XML) messages.

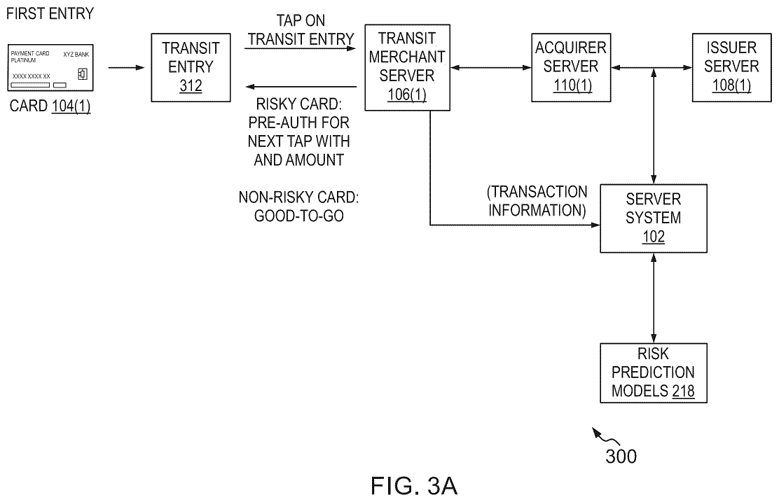

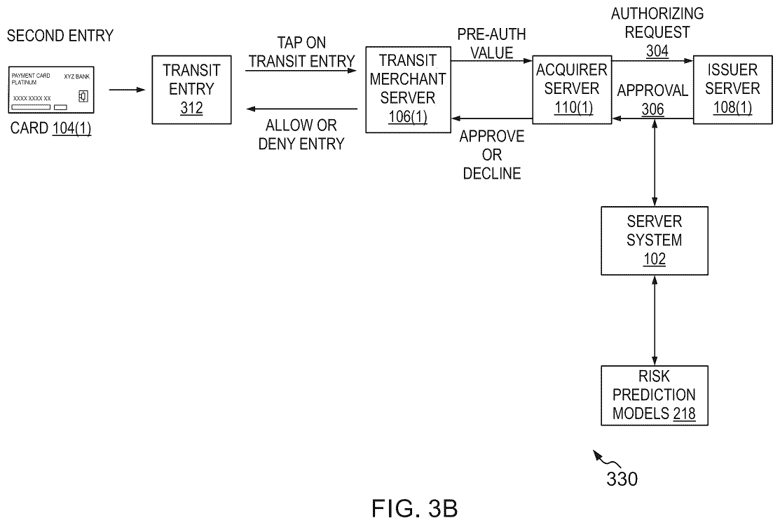

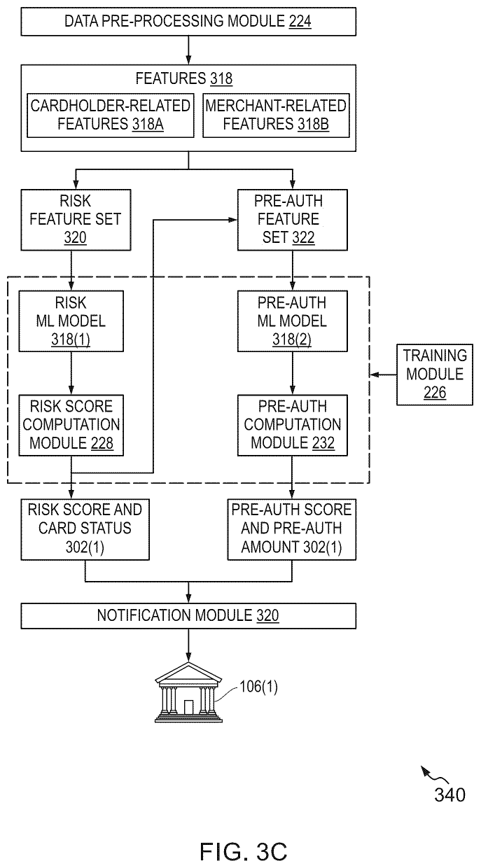

FIG. 3A illustrates a block diagram representation 300 depicting a process flow for first transit entry associated with a new card, in accordance with an embodiment of the present disclosure.

In a scenario, the cardholder such as card 104(1) may perform tapping card at (referred to as a first entry in the present scenario) at a transit entry terminal such as transit entry 301 to make a transaction request (see, tap on transit entry) for accessing transit service. To perform such transactions the card information is scanned at the transit entry 301. For instance, the card details may include a card expiration date, a cardholder name, or so on. The transit merchant 106(1) is configured to transmit this the transaction information to the server system 102. Additionally, upon receiving this payment card information from the transit merchant server 106(1), the acquirer server 110(1) is configured to transmit an authentication request message (see, 304) to the issuer server 108(1) of the issuing bank of the cardholder 104(1). The issuer server 108(1) may then authenticate the identity of the cardholder 104(1) using a variety of authenticating techniques. Such authenticating techniques are well known in the art; therefore they are not explained here for the sake of brevity. Upon unsuccessful authentication, the payment process is terminated. On the other hand, if the cardholder 104(1) is authenticated successfully, the issuer server 110(1) transmits the payment authorization message (see, 306) to the acquirer 110(1) via the server system 200.

When the server system 200 receives a payment authentication request message such as transaction information, the server system 200 utilizes one or more risk prediction models 218 associated with it to compute the risk score 302(1) along with card status and the pre-auth score 302(2) along with the pre-auth amount such as pre-auth for next tap with amount value for the payment card having status as risky, for the transaction request. The process for computing the risk score and the pre-auth score have been described in further detail with reference to FIG. 3C.

In an instance, the risk score and the pre-auth score may be utilized by the server system 200 to determine if the card status as risky (may be called risky label) or non-risky (may be called non-risky label) and a pre-auth amount for the new card with status as risky. For instance, if the risk score is lower than the predefined risk threshold, a risk indication message such as “non-risky card: good-to-go” is generated and transmitted to the merchant 106(1). In some instances, the message may be shared using an API message or an XML message.

In an alternative instance, if the risk score is at least equal to the predefined risk threshold, a pre-auth amount such as pre-auth for next tap with amount is generated based on the pre-auth score and the card status. Thereafter, the notification module 230 of the server system 200 is configured to generate a message e.g. “Risky card: pre-auth for next tap with the pre-auth amount value” (see card status+pre-auth amount value in FIG. 3A). Further, the risk indication message is transmitted to the transit merchant 106(1). In some instances, the risk indication message may be shared using an API message or an XML message. It should be noted that the server system 200 may transmit card status and the pre-auth amount along with their respective risk score and pre-auth amount via the message to a transit merchant 106(1)

FIG. 3B illustrates a block diagram representation 330 depicting a process flow for second transit entry associated with a new card having a card status as risky (or risky label), in accordance with an embodiment of the present disclosure.

In a scenario, the cardholder such as card with risky status (which is valid at least till the second tapping is performed) may perform tapping card at (referred to as a second entry in the present scenario) at a transit entry terminal such as transit entry 312 to make a transaction request for accessing transit service. The transit merchant 106(1) is configured to transmit this card information along with the pre-auth amount such as pre-auth amount, generated from the server system 102, to their corresponding acquiring bank through the acquirer server 110(1). Upon receiving this card information, the acquirer server 110(1) is configured to transmit an authorization request message (see, 304) to the issuer server 108(1) of the issuing bank of the cardholder 104(1). The issuer server 108(1) may then authorize the transaction by verifying the identity of the card and available funds along with the pre-auth amount associated the card, using a variety of authenticating techniques. If the payment is authorized, then the cardholder 104(1) is allowed entry otherwise, they are not allowed to entry.

FIG. 3C illustrates a block diagram representation 340 depicting a process flow for generating a risk score (e.g., a risk score 302(1)) and a pre-auth score (e.g., a pre-auth score 302(2)), in accordance with an embodiment of the present disclosure.

Upon receipt of the payment authentication message (may also be assumed on the first entry (see FIG. 3A)), the server system 200 is configured to utilize the data pre-processing module 224 to generate a plurality of features (see, features 318) based on both the information associated with the first entry transaction associated with the new card and the plurality of historical transactions. The plurality of features 318 may include, but not limited to, features related to entities in the four-party framework, i.e., the cardholder, and the merchant. In other words, the plurality of features 318 may include a set of cardholder-level features see, cardholder-related features 318A, and a set of merchant-level features see, merchant-related features 318B. Further, these features 318 may be segregated into the risk feature set 320 and the pre-auth feature set 322. Each of these different types of feature sets can be used by AI/ML models to generate the risk score and a card status 302(1) and the pre-auth score and pre-auth amount 302(2).

To achieve this, the server system 200 is configured to compute a transaction risk score and a card status 302(1). In particular, the server system 200 is configured to utilize at least one model (called, the risk ML model 318(1)) from the one or more risk prediction models 218 (see risk prediction models 218). More specifically, the at least one model is configured to compute the transaction risk score based, at least in part, on the risk feature set 320 Herein, the risk feature set 320 includes at least one of the first card level feature set and the first merchant level feature set.

Similarly, server system 200 is configured to compute a pre-auth score and pre-auth amount 302(2). In particular, the server system 200 is configured to utilize at least another model (called, the pre-auth ML model 318(2)) from the one or more risk prediction models 218. It should be noted that if the risk computation module 228 outcome represents card status as non-risky (or non-risky label), then the new card is a good-to-go and further no need for computation of pre-auth score.

Once, the risk score (see risk score and card status 302(1)) and the pre-auth score 302(2) (see pre-auth score and pre-auth amount 302(2)) are determined, the server system 200 is configured to utilize the notification module 230 to generate and transmit one or more messages which includes at least card status such as risky label or non-risky label and the pre-auth amount associated with the payment card, to the transit merchant server 106(1) based on at least one of the card status and the pre-auth score.

In an alternative embodiment, the risk score 302(1) may include a numeric score along with a flag indicating card status as risky label or non-risky label. Similarly, the pre-auth score 302(2) may include a numeric score along with pre-auth amount.

In an additional embodiment, the server system 200 is configured to transmit (may be using a notification module 320) the risk indication message including at least the card status and the pre-auth amount to the merchant 106(1), upon identifying that the payment card is associated with a non-risky label.

FIG. 4A illustrates a schematic representation 400 of a process of training of the one or more risk prediction models (e.g., the one or more clearance prediction models 120) for generating the risk score 302(1) and the pre-auth score 302(2), in accordance with an embodiment of the present disclosure. In a non-limiting example, the one or more risk prediction models 120 may include a risk ML model and a pre-auth ML model. Further, it is noted that for the sake of explanation, although, the one or more risk prediction models are considered to be eXtreme Gradient Boosting (XGBoost), the same should not be construed as a limitation. To that end, one or more risk prediction models can be any decision tree based ML models.

Herein each of the risk ML model 318(1) and the pre-auth ML model 318(2) may be trained and generated separately and independently for separate purposes as mentioned earlier in the present disclosure, and then based on outputs obtained from each of the risk ML model 318(1), and the pre-auth ML model 318(2), the risk score 302(1) and the pre-auth score 302(2) may be generated respectively.

Moreover, as may be understood that, in an embodiment, each of the one or more risk prediction models 120 may be a Gradient Boosting Machine (GBM) model or an extreme gradient boosting (XGBoost) model, training steps of each of the one or more risk prediction models 120 and the features provided to each of the one or more risk prediction models 120 may be same or different without any limitation.

As used herein, the term “Gradient Boosting” refers to a popular boosting algorithm in machine learning used for classification and regression tasks. It may be noted that boosting is one kind of ensemble learning method that trains the model sequentially and each new model tries to correct the previous model. It combines several weak learners into strong learners. Similarly, as used herein, the term “extreme gradient boosting” refers to a type of boosting algorithm in machine learning which is similar to the GBM model, however, the difference is in model details, for example, the XGBoost model in comparison to the GBM model is more regularized model formalization to control a problem of over-fitting, which gives a better performance.

As may be understood, the XGBoost model is a scalable tree boosting system that can solve real-world problems with remarkable performance using minimal resources. Herein, the XGBoost model receives an input data 402. In an embodiment, the input data 402 may be similar to the historical transaction dataset 220 along with the feature sets extracted from the first entry transaction (as in FIG. 3A). In an embodiment, the input data 402 may be split into training data and testing data, whereby the training data may be used while training the XGBoost model and the testing data may be used while testing whether the XGBoost model is functioning as per its purpose of training or not.

Further, the XGBoost model produces individual decision trees (e.g., decision trees 404(1), 404(2), . . . 404(M) where ‘M’ is a non-zero Natural number, hereinafter, interchangeably referred to as decision trees 404 sequentially, where a subset of the training data for each subsequent tree (e.g., the decision tree 404(2) is chosen based on the performance of the previous decision trees (e.g., the decision tree 404(1)), as shown in FIG. 4A. More specifically, each decision tree is trained on the examples that were incorrectly classified by the previous classifiers.

It may be noted that the XGBoost model uses Newton boosting, a second-order gradient boosting technique based on the gradient descent algorithm which aims to minimize the loss when adding new models or decision trees. Therefore, each new decision tree corrects the errors made by the previous trees. This will finally produce ‘M’ decision trees, where ‘M’ depends on the number of predetermined iterations for the algorithm, which provide ‘M’ predictions 406(1), 406(2), . . . 406(M) where ‘M’ is a non-zero natural number, hereinafter, interchangeably referred to as predictions 406).

Further, the final classification is made by combining the outputs (e.g., the predictions 406) of all the classifiers (decision trees) with the chosen weighting and averaging method. In other words, it may be noted that an average of the predictions 406 (see, 408) may be performed by the XGBoost model for obtaining a final prediction 410 as shown in FIG. 4A. It is understood that the process of FIG. 4A may be performed to train any model from the one or more risk prediction models 218.

FIG. 4B illustrates a flow diagram representation 460 of a process flow of training the one or more risk prediction models 120, in accordance with an embodiment of the present disclosure. In a non-limiting example, the one or more risk prediction models 120 may include the risk ML model 318(1) and the pre-auth ML model 318(2). In another example, the one or more risk prediction models 120 may include any number of ML models without limiting the scope of the present disclosure. Herein, in an embodiment, each model of the one or more risk prediction models 120 may be trained via the training module 226 by performing a set of operations iteratively till the performance of the said model converges to predefined criteria. In a non-limiting example, each model of the one or more risk prediction models 120 may be an XGBoost model whose basic functionality has already been explained earlier with reference to FIG. 4A.

In an embodiment, the set of operations may include model initialization 462, decision tree generation 464, optimization parameters computation 466, new decision tree generation 468, weights assignment 470, ensemble decision trees 472, optimize model parameters 474, and check whether the performance of the ML model (e.g., each of the one or more clearance prediction models 120) converged to the predefined criteria (see, 476). In case the ML model converges to the predefined criteria, the training of the ML model stops (see, 478), otherwise, the set of operations in the training of the ML model would be repeated as shown in FIG. 4B.

Since, the XGBoost model is a supervised learning model, the model may use the training data with the plurality of features say ‘xᵢ’ that are independent variables to predict a target variable say ‘ŷᵢ’ that may be labeled for classification task or numerical values for regression task.

In an embodiment, basic elements of supervised learning may include a mathematical model and parameters associated with the mathematical model and objective function which is a combination of a training loss and regularization. Examples of mathematical models include exponential decay, exponential growth, quadratic function, and linear function. In a non-limiting example, when a linear model may be considered, the prediction may be given by the following equation:

$${\hat{y}}_{i} = {\sum }_{j} {θ}_{j} {x}_{ij} \qquad Eqn . 1$$

Herein, the Eqn. 1 may correspond to a linear combination of weighted input features (xᵢⱼ) and ‘θⱼ’ may refer to a coefficient/parameter that is used as weights multiplied with the input features. Further, it may be noted that the task of training the model amounts to finding the best parameters ‘θ’ that best fit the training data and labels. To train the model, the objective function may have to be defined to measure how well the model fits the training data.

A salient characteristic of the objective function is that it consists of two parts: training loss and regularization term and is represented by the following equation:

$$obj ( θ ) = L ( θ ) + Ω ( θ ) \qquad Eqn . 2$$

Herein, ‘L’ is the loss function, and ‘Ω’ is the regularization term. In some embodiments, the loss function may include mean squared loss, logistic loss, or the like. The regularization term controls the complexity of the model, which helps avoid overfitting.

In another embodiment, other parameters may include hyperparameters such as, but not limited to, a number of boosting rounds, a learning rate, a maximum tree depth, and the like. In some embodiments, the regularization terms may be two in number. It is important to carefully tune these parameters for better model performance.

In an embodiment, the step of model initialization 462 may include initializing an ML model (e.g., the risk ML model or the pre-auth ML model) of the one or more risk prediction models 120 based, at least in part, on one or more model parameters and an initial prediction. In a non-limiting example, the one or more model parameters may include the parameters and the hyperparameters such as initial weights, number of trees, layer and so on. Herein, the initial prediction may include a simple prediction such as a means of the target values for regression tasks, or the most frequent class for classification tasks.

In another embodiment, the step of decision tree generation 464 may include a step of generating a set of classification and regression trees. In this step, based on the training data a decision tree may be generated. In other words, it may be noted that this step includes generating a decision tree for generating predictions 406 (as shown in FIG. 4A) based, at least in part, on the pre-auth feature set 322 and the risk feature set 320. Herein, the feature set being selected for training may be dependent upon whether the ML model being trained is the risk ML model or the pre-auth ML model.

Later, the step of optimization parameters computation 466 may be implemented. Herein, the ML model may compute one or more optimization parameters based at least on the performance of the decision tree, using one or more optimization functions. In a non-limiting example, the one or more optimization parameters may include a loss function, a gradient (first derivative) of the loss function, a hessian (second derivative) of the loss function, and the like. Herein, it may be noted that each of the one or more parameters may be computed using their respective optimization functions. More specifically, it may be noted that the gradient indicates how much the predictions need to be updated to reduce the overall loss. Similarly, hessian is used to adjust the step size (learning rate) during the optimization process.

Further, in an embodiment, the step of new decision tree generation 468 may include building a new decision tree for reducing the one or more optimization parameters. Herein, it may be noted that the new decision tree may reduce the one or more optimization parameters by capturing patterns and relationships that were not well-modeled by the previous trees.

In an embodiment, the step of weights assignment 470 may include assigning weights to the new decision tree and the previously generated decision tree based, at least in part, on a performance of the new decision tree and the previously generated decision tree in reducing the one or more optimization parameters. For example, decision trees that contribute more to the model's predictive performance receive higher weights.

Later, in an embodiment, the step of ensemble decision trees 472 may be performed which includes generating an ensemble of a plurality of decision trees (such as decision trees 404, as shown in FIG. 4A) by adding predictions (e.g., prediction 406(2) of the new decision tree to predictions (e.g., prediction 406(1) of the previously generated decision tree. Lastly, the step of optimizing model parameters 474 may be performed which includes optimizing the one or more model parameters for the corresponding ML model of the one or more risk prediction models 120.

Upon obtaining the ensemble of the decision trees 404 and optimizing the one or more model parameters, the performance of the ML model is checked for its convergence to the predefined criteria. If the performance of the ML model converges to the predefined criteria, the training process stops (see, 478), otherwise, the process repeats, until the corresponding convergence is achieved.

In some embodiments, the predefined criteria for the convergence of the ML model may be dependent on one or more factors such as a number of iterations or trees, a minimum improvement in loss, validation set performance, and early stopping criteria. Herein, in an embodiment, the factor of the number of iterations or trees may refer to a criterion in which a maximum number of iterations is fixed for the training process and once the model reaches that number, the training process stops. In another embodiment, the factor of the minimum improvement in loss may refer to a criterion in which a minimum improvement in the loss function in consecutive iterations is observed and if the improvement falls below a predefined threshold the training process stops.

In yet another embodiment, the factor of validation set performance may refer to monitoring the performance of the model on a validation set at each iteration and if the performance of the model on the validation set does not improve or starts to degrade, then the training process stops. Further, in an embodiment, the factor of early stopping criteria may refer to a criterion that may be chosen to prevent overfitting. It involves dividing the training data into training and validation sets. The training process continues until the performance on the validation set stops improving, and then the model with the best performance on the validation set is selected as the final model.

Further, it may be noted that in an embodiment, the server system 200 may generate or learn the risk ML model 318(1) via the training module 226. The training module 226 may perform a first set of operations to generate the risk ML model 318(1). Upon performing the first set of operations, the risk ML model 318(1) may get trained using the historical transaction dataset 220 and learn to generate a likelihood score for a transaction to be cleared. Herein, the risk ML model 318(1) may be based on the first set of features. For the scenario of the present invention, the risk ML model 318(1) may be a binary classification model using XGBoost with BCE (Binary Cross-Entropy) loss function and a neural network with one neuron in the last layer trained using BCE loss. When using XGBoost for binary classification, the objective function typically involves minimizing the Binary Cross-Entropy (BCE) loss function. The BCE loss function is defined as:

$$BCE Loss = - \frac{1}{N} {\sum }_{i = 1}^{N} [ {y}_{i} \cdot log ( {p}_{i} ) + ( 1 - {y}_{i} ) \cdot log ( 1 - {p}_{i} ) \qquad Eqn . 3$$

Where n is the number of instances in the dataset, y; is the true label of instance i (either 0 or 1), and p is the predicted probability that instance i belongs to class 1.

Similarly, the pre-auth ML model 318(2) may get trained using the historical transaction dataset 220 and learn to generate a likelihood score for a transaction to be disputed. Herein, the pre-auth ML model 318(2) may be based on the different features than those used by the risk ML model 318(1). Further, for the scenario of the present invention, the pre-auth ML model 318(2) may be a multiclass classification model using XGBoost with the Multi-class Cross-Entropy loss function and a neural network with multiple neurons in the last layer trained using the same loss function. For multiclass classification, XGBoost typically employs the Multi-class Cross-Entropy loss function, also known as the softmax loss function. The Multi-class Cross-Entropy loss function is defined as:

$$Cross Entropy Loss = - \frac{1}{N} {\sum }_{i = 0}^{N} {\sum }_{k = 0}^{K} [ {y}_{ik} \cdot log ( {p}_{ik} ) ] \qquad Eqn . 4$$

Where n is the number of instances in the dataset, K is the number of classes, yᵢₖ is the indicator function which equals 1 if instance i belongs to class k and 0 otherwise, pᵢₖ is the predicted probability that instance i belongs to class k.

Moreover, it may be noted that the set of operations performed for training each of the risk ML model 318(1) and the pre-auth ML 318(2) model may be the same as described above with reference to the step of model initialization 462 to the step of checking the performance of the model (see, 476) with the difference being the set of features on which the training process is implemented and number of neuron in the last layer trained of the neural network for each model.

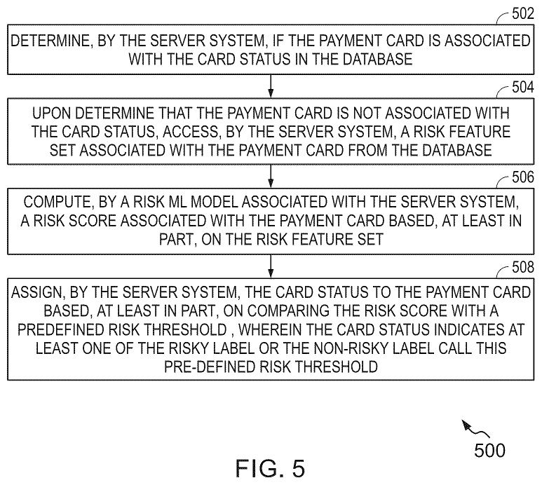

FIG. 5 illustrates a process flow diagram depicting a method 500 for identifying the card status, in accordance with an embodiment of the present disclosure. The sequence of operations of the method 500 may not be necessarily executed in the same order as they are presented. Further, one or more operations may be grouped and performed in the form of a single step, or one operation may have several sub-steps that may be performed in parallel or in a sequential manner. Operations of the method 500, and combinations of operations in the method 500 may be implemented by, for example, hardware, firmware, a processor, circuitry, and/or a different device associated with the execution of software that includes one or more computer program instructions. The plurality of operations is depicted in the process flow of the method 500. The process flow starts at operation 502.

At 502, the method 500 includes determining, by the server system 200, if the payment card is associated with the card status in the database.

At 504, the method 500 includes accessing, by the server system 200, a risk feature set associated with the payment card from the database, upon determining that the payment card is not associated with the card status.

At 506, the method 500 includes computing, by a risk ML model associated with the server system 200, a risk score associated with the payment card based, at least in part, on the risk feature set.

At 508, the method 500 includes assigning, by the server system 200, the card status to the payment card based, at least in part, on comparing the risk score with a predefined risk threshold, wherein the card status indicates at least one of the risky label or the non-risky label.

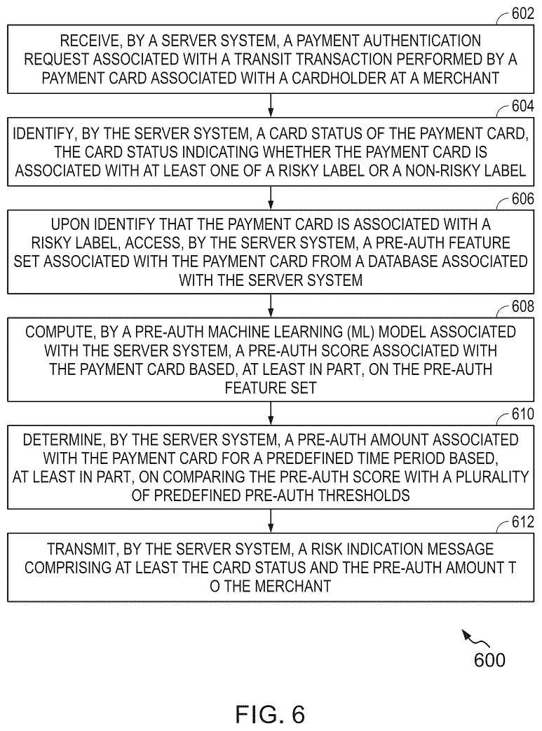

FIG. 6 illustrates a process flow diagram depicting a method 600 for processing a payment authentication request associated with a transit transaction, in accordance with an embodiment of the present disclosure. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 600.

At 602, the method 600 includes receiving, by a server system 200, a payment authentication request associated with a transit transaction performed by a payment card associated with a cardholder at a merchant 106(1).

At 604, the method 600 includes identifying, by the server system 200, a card status of the payment card, the card status indicating whether the payment card is associated with at least one of a risky label or a non-risky label.

At 606, the method 600 includes accessing, by the server system, a pre-auth feature set associated with the payment card from a database associated with the server system, upon identifying that the payment card is associated with a risky label.

At 608, the method 600 includes computing, by a pre-auth Machine Learning (ML) model associated with the server system, a pre-auth score associated with the payment card based, at least in part, on the pre-auth feature set.

At 610, the method 600 includes determining, by the server system, a pre-auth amount associated with the payment card for a predefined time period based, at least in part, on comparing the pre-auth score with a plurality of predefined pre-auth thresholds.

At 612, the method 600 includes transmitting, by the server system 200, a risk indication message including at least the card status and the pre-auth amount to the merchant.

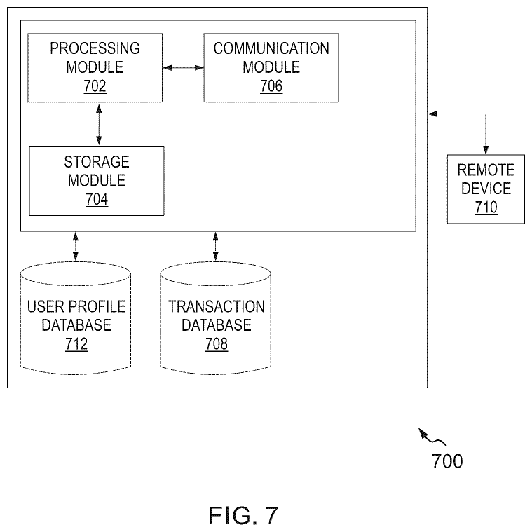

FIG. 7 illustrates a simplified block diagram of an acquirer server 700, in accordance with an embodiment of the present disclosure. The acquirer server 700 is an example of the acquirer servers 110 of FIG. 1. The acquirer server 700 is associated with an acquirer bank/acquirer, in which a merchant 106 may have an account, which provides a payment card. The acquirer server 700 includes a processing module 702 operatively coupled to a storage module 704 and a communication module 706. The components of the acquirer server 700 provided herein may not be exhaustive, and the acquirer server 700 may include more or fewer components than those depicted in FIG. 7. Further, two or more components may be embodied in one single component, and/or one component may be configured using multiple sub-components to achieve the desired functionalities. Some components of the acquirer server 700 may be configured using hardware elements, software elements, firmware elements, and/or a combination thereof.

The storage module 704 is configured to store machine-executable instructions to be accessed by the processing module 702. Additionally, the storage module 704 stores information related to, the contact information of the merchant 106, bank account number, availability of funds in the account, payment card details, transaction details, and/or the like. Further, the storage module 704 is configured to store transactions associated with the merchant 106.

In one embodiment, the acquirer server 700 is configured to store profile data (e.g., an account balance, a credit line, details of the cardholders 104, account identification information, and a payment card number) in a transaction database 708. The details of the cardholders 104 may include, but are not limited to, name, age, gender, physical attributes, location, registered contact number, family information, alternate contact number, registered e-mail address, etc.

The processing module 702 is configured to communicate with one or more remote devices such as a remote device 710 using the communication module 706 over a network such as the network 118 of FIG. 1. The examples of the remote device 710 include the server system 102, the payment server 114, the issuer servers 108, or other computing systems of the acquirer server 700, and the like. The communication module 706 can facilitate such operative communication with the remote devices and cloud servers using Application Program Interface (API) calls. The communication module 706 is configured to receive a payment transaction request performed by the cardholders 104 via the network 118. The processing module 702 receives payment card information, a payment transaction amount, cardholder information, and merchant information from the remote device 710 (i.e., the payment server 114). The acquirer server 700 includes a user profile database 712 and the transaction database 708 for storing transaction data. The user profile database 712 may include information about the cardholders 104. The transaction data may include, but is not limited to, transaction attributes, such as transaction amount, source of funds such as bank or credit cards, transaction channel used for loading funds such as POS terminal or ATM, transaction velocity features such as count and transaction amount sent in the past x days to a particular user, transaction location information, external data sources, pre-auth transactions, failed transactions, disputed transactions, non-cleared transactions and other internal data to evaluate each transaction.

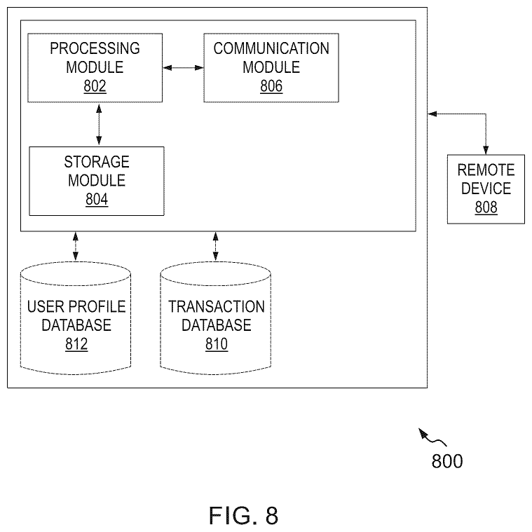

FIG. 8 illustrates a simplified block diagram of an issuer server 800, in accordance with an embodiment of the present disclosure. The issuer server 800 is an example of the issuer servers 108 of FIG. 1. The issuer server 800 is associated with an issuer bank/issuer, in which an account holder (e.g., the cardholders 104(1)-104(N)) may have an account, which provides a payment card. The issuer server 800 includes a processing module 802 operatively coupled to a storage module 804 and a communication module 806. The components of the issuer server 800 provided herein may not be exhaustive and the issuer server 800 may include more or fewer components than those depicted in FIG. 8. Further, two or more components may be embodied in one single component, and/or one component may be configured using multiple sub-components to achieve the desired functionalities. Some components of the issuer server 800 may be configured using hardware elements, software elements, firmware elements, and/or a combination thereof.

The storage module 804 is configured to store machine-executable instructions to be accessed by the processing module 802. Additionally, the storage module 804 stores information related to, the contact information of the cardholders (e.g., the cardholders 104(1)-104(N)), a bank account number, availability of funds in the account, payment card details, transaction details, payment account details, and/or the like. Further, the storage module 804 is configured to store transactions associated with the cardholders 104.

In one embodiment, the issuer server 800 is configured to store profile data (e.g., an account balance, a credit line, details of the cardholders 104, account identification information, payment card number, etc.) in a database. The details of the cardholders 104 may include, but are not limited to, name, age, gender, physical attributes, location, registered contact number, family information, alternate contact number, registered e-mail address, or the like of the cardholders 104.

The processing module 802 is configured to communicate with one or more remote devices such as a remote device 808 using the communication module 806 over a network such as the network 118 of FIG. 1. Examples of the remote device 808 include the server system 200, the payment server 114, the acquirer servers 110 or other computing systems of the issuer server 800. The communication module 806 can facilitate such operative communication with the remote devices 808 and cloud servers using Application Program Interface (API) calls. The communication module 806 is configured to receive a payment transaction request performed by an account holder (e.g., the cardholder 104(1)) via the network 118. The processing module 802 receives payment card information, a payment transaction amount, customer (or cardholder) information, and merchant information from the remote device 808 (e.g., the payment server 114). The issuer server 800 includes a transaction database 810 for storing transaction data. The transaction data may include, but is not limited to, transaction attributes, such as transaction amount, source of funds such as bank or credit cards, transaction channel used for loading funds such as POS terminal or ATM, preauthorization transactions, transaction velocity features such as count and transaction amount sent in the past x days to a particular account holder, transaction location information, external data sources, and other internal data to evaluate each transaction. The issuer server 800 includes a user profile database 812 storing user profiles associated with the plurality of account holders.

The user profile data may include an account balance, a credit line, details of the account holders, account identification information, payment card number, or the like. The details of the account holders (e.g., the cardholders (104(1)-104(N)) may include, but are not limited to, name, age, gender, physical attributes, location, registered contact number, family information, alternate contact number, registered e-mail address, or the like of the cardholders 104.

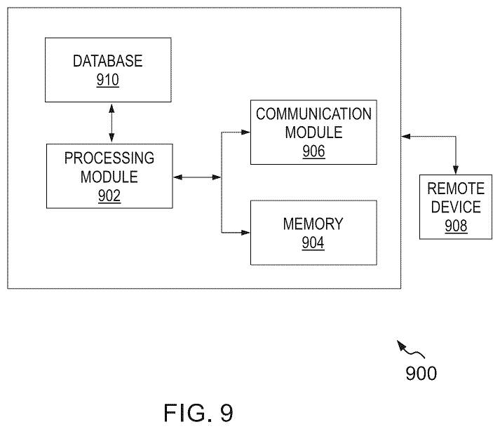

FIG. 9 illustrates a simplified block diagram of the payment server 900, in accordance with an embodiment of the present disclosure. The payment server 900 is an example of the payment server 114 of FIG. 1. The payment server 900 and the server system 200 may use the payment network 112 as a payment interchange network. Examples of payment interchange networks include, but are not limited to, fintech payment system interchange network.

The payment server 900 includes a processing module 902 configured to extract programming instructions from a memory 904 to provide various features of the present disclosure. The components of the payment server 900 provided herein may not be exhaustive, and the payment server 900 may include more or fewer components than that depicted in FIG. 9. Further, two or more components may be embodied in one single component, and/or one component may be configured using multiple sub-components to achieve the desired functionalities. Some components of the payment server 900 may be configured using hardware elements, software elements, firmware elements, and/or a combination thereof.

Via a communication module 906, the processing module 902 receives a request from a remote device 908, such as the issuer servers 108, the acquirer servers 110, or the server system 102. The request may be a request for conducting the payment transaction. The communication may be achieved through API calls, without loss of generality. The payment server 900 includes a database 910. The database 910 also includes transaction processing data such as issuer ID, country code, acquirer ID, and merchant identifier (MID), among others.

When the payment server 900 receives a payment transaction request from the acquirer servers 110 or a payment terminal (e.g., IoT device), the payment server 900 may route the payment transaction request to the issuer servers 108. The database 910 stores transaction identifiers for identifying transaction details such as transaction amount, IoT device details, acquirer account information, transaction records, merchant account information, and the like.

In one example embodiment, the acquirer servers 110 are configured to send an authorization request message to the payment server 800. The authorization request message includes, but is not limited to, the payment transaction request.

The processing module 902 further sends the payment transaction request to the issuer servers 108 for facilitating the payment transactions from the remote device 908. The processing module 902 is further configured to notify the remote device 908 of the transaction status in the form of an authorization response message via the communication module 906. The authorization response message includes, but is not limited to, a payment transaction response received from the issuer servers 108. Alternatively, in one embodiment, the processing module 902 is configured to send an authorization response message for declining the payment transaction request, via the communication module 906, to the acquirer servers 110. In one embodiment, the processing module 902 executes similar operations performed by the server system 200, however, for the sake of brevity, these operations are not explained herein.

In one example embodiment, the acquirer servers 110 are configured to receive an authorization request message from the transit merchant server 900. The authorization request message includes, but is not limited to, the payment transaction request or a pre-authorization request.

The disclosed method with reference to FIG. 5, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during the implementation of the disclosed methods or systems may also be stored on one or more computer-readable media (e.g., non-transitory computer-readable media) and are within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad scope of the invention. For example, the various operations, blocks, etc., described herein may be enabled and operated using hardware circuitry (for example, complementary metal oxide semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media includes any type of tangible storage media.

Examples of non-transitory computer-readable media include magnetic storage media (such as floppy disks, magnetic tapes, hard disk drives, etc.), optical magnetic storage media (e.g. magneto-optical disks), CD-ROM (compact disc read-only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different from those which are disclosed. Therefore, although the invention has been described based on these exemplary embodiments, it is noted that certain modifications, variations, and alternative constructions may be apparent and well within the scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system, a payment authentication request associated with a transit transaction performed by a payment card associated with a cardholder at a merchant;
identifying, by the server system, a card status of the payment card, the card status indicating whether the payment card is associated with at least one of a risky label or a non-risky label;
upon identifying that the payment card is associated with a risky label, accessing, by the server system, a pre-auth feature set associated with the payment card from a database associated with the server system;
computing, by a pre-auth Machine Learning (ML) model associated with the server system, a pre-auth score associated with the payment card based, at least in part, on the pre-auth feature set;
determining, by the server system, a pre-auth amount associated with the payment card for a predefined time period based, at least in part, on comparing the pre-auth score with a plurality of predefined pre-auth thresholds; and
transmitting, by the server system, a risk indication message comprising at least the card status and the pre-auth amount to the merchant.

2. The computer-implemented method as claimed in claim 1, wherein identifying the card status comprises:
determining, by the server system, if the payment card is associated with the card status in the database;
upon determining that the payment card is not associated with the card status, accessing, by the server system, a risk feature set associated with the payment card from the database;
computing, by a risk ML model associated with the server system, a risk score associated with the payment card based, at least in part, on the risk feature set; and
assigning, by the server system, the card status to the payment card based, at least in part, on comparing the risk score with a predefined risk threshold, wherein the card status indicates at least one of the risky label or the non-risky label.

3. The computer-implemented method as claimed in claim 2, wherein accessing the risk feature set comprises:
accessing, by the server system, a historical transaction dataset from the database, the historical transaction dataset comprising transaction-related information associated with a plurality of transactions performed by a plurality of cardholders with a plurality of merchants;
generating, by the server system, the risk feature set based, at least in part, on the transaction-related information associated with the plurality of transactions, wherein the risk feature set comprises a set of first card-level features and a set of first merchant-level features; and
storing, by the server system, the risk feature set in the database.

4. The computer-implemented method as claimed in claim 2, wherein the risk ML model is a binary classification model.

5. The computer-implemented method as claimed in claim 1, wherein the card status associated with the payment card is valid for a predefined status time interval.

6. The computer-implemented method as claimed in claim 1, further comprising:
upon identifying that the payment card is associated with a non-risky label, transmitting, by the server system, the risk indication message comprising at least the card status to the merchant.

7. The computer-implemented method as claimed in claim 1, wherein accessing the pre-auth feature set comprises:
accessing, by the server system, a historical transaction dataset from the database, the historical transaction dataset comprising transaction-related information associated with a plurality of transactions performed by a plurality of cardholders with a plurality of merchants;
generating, by the server system, the pre-auth feature set based, at least in part, on the transaction-related information associated with the plurality of transactions, wherein the pre-auth feature set comprises a set of second card-level features and a set of second merchant-level features; and
storing, by the server system, the pre-auth feature set in the database.

8. The computer-implemented method as claimed in claim 1, wherein the predefined time period indicates a time interval during which the merchant has to transmit a clearing request message for the pre-auth amount to the issuer server associated with the cardholder.

9. The computer-implemented method as claimed in claim 1, wherein the pre-auth ML model is a multiclass classification model.

10. The computer-implemented method as claimed in claim 1, wherein the server system is a payment server associated with a payment network.

11. A server system comprising:
a communication interface;
a memory comprising executable instructions; and
a processor communicably coupled to the communication interface and the memory, the processor configured execute the instruction to cause the server system to at least:
receive a payment authentication request associated with a transit transaction performed by a payment card associated with a cardholder at a merchant;
identify a card status of the payment card, the card status indicating whether the payment card is associated with at least one of a risky label or a non-risky label;
upon identifying that the payment card is associated with a risky label, access a pre-auth feature set associated with the payment card from a database associated with the server system;
compute a pre-auth score associated with the payment card based, at least in part, on the pre-auth feature set using a pre-auth Machine Learning (ML) Model associated with the server system;
determine a pre-auth amount associated with the payment card for a predefined time period based, at least in part, on comparing the pre-auth score with a plurality of predefined pre-auth thresholds; and
transmit a risk indication message comprising at least the card status and the pre-auth amount to the merchant.

12. The server system as claimed in claim 11, wherein to identify the card status, the server system is caused, at least in part, to:
determine if the payment card is associated with the card status in the database;
upon determining that the payment card is not associated with the card status, access a risk feature set associated with the payment card from the database;
compute, using a risk ML model associated with the server system, a risk score associated with the payment card based, at least in part, on the risk feature set; and
assign the card status to the payment card based, at least in part, on comparing the risk score with a first predefined risk threshold, wherein the card status indicates at least one of the risky label or the non-risky label.

13. The server system as claimed in claim 12, wherein to access the risk feature set, the server system is caused, at least in part, to:
access a historical transaction dataset from the database, the historical transaction dataset comprising transaction-related information associated with a plurality of transactions performed by a plurality of cardholders with a plurality of merchants;
generate the risk feature set based, at least in part, on the transaction-related information associated with the plurality of transactions, wherein the risk feature set comprises a set of first card-level features and a set of first merchant-level features; and
store the risk feature set in the database.

14. The server system as claimed in claim 11, wherein the card status associated with the payment card is valid for a predefined status time interval.

15. The server system as claimed in claim 11, the server system is further caused to:
upon identifying that the payment card is associated with a non-risky label, transmit the risk indication message comprising at least the card status to the merchant.

16. The server system as claimed in claim 11, wherein to access the pre-auth feature set, the server system is caused, at least in part, to:
access a historical transaction dataset from the database, the historical transaction dataset comprising transaction-related information associated with a plurality of transactions performed by a plurality of cardholders with a plurality of merchants;
generate the pre-auth feature set based, at least in part, on the transaction-related information associated with the plurality of transactions, wherein the pre-auth feature set comprises a set of second card-level features and a set of second merchant-level features; and
store the pre-auth feature set in the database.

17. The server system as claimed in claim 11, wherein the predefined time period indicates a time interval during which the merchant has to transmit a clearing request message for the pre-auth amount to the issuer server associated with the cardholder.

18. The server system as claimed in claim 11, wherein the server system is a payment server associated with a payment network.

19. A non-transitory computer-readable medium comprising computer-executable instructions that, when executed by at least a processor of a server system, cause the server system to perform a method comprising:
receiving a payment authentication request associated with a transit transaction performed by a payment card associated with a cardholder at a merchant;
identifying a card status of the payment card, the card status indicating whether the payment card is associated with at least one of a risky label or a non-risky label;
upon identifying that the payment card is associated with a risky label, accessing a pre-auth feature set associated with the payment card from a database associated with the server system;
computing, by a pre-auth Machine Learning (ML) model associated with the server system, a pre-auth score associated with the payment card based, at least in part, on the pre-auth feature set;
determining a pre-auth amount associated with the payment card for a predefined time period based, at least in part, on comparing the pre-auth score with a plurality of predefined pre-auth thresholds; and
transmitting a risk indication message comprising at least the card status and the pre-auth amount to the merchant.

20. The non-transitory computer-readable medium of claim 19, wherein to identify the card status, the server system is caused, at least in part, to perform:
receiving a payment authentication request at the transit entry using the payment card;
accessing a risk feature set associated with the payment card from the database;
computing, using a risk ML model associated with the server system, a risk score associated with the payment card based, at least in part, on the risk feature set; and
assigning the card status to the payment card based, at least in part, on comparing the risk score with a predefined risk threshold, wherein the card status indicates at least one of the risky label or the non-risky label.
